(19) United States
(12) Patent Application Publication
(10) Pub. No.: US 2011/0276295 A1
(43) Pub. Date: Nov. 10, 2011

(54) METHOD OF MONITORING THE VOLTAGE OF AN ELECTRICAL ENERGY GENERATING ELEMENT OF A BATTERY

(75) Inventors: Fabien Gaben, Ecully (FR); Claude Beignet, Meudon (FR)

(73) Assignee: DOW KOKAM FRANCE SAS, Massy (FR)

(21) Appl. No.: 13/108,595

(22) Filed: May 16, 2011

Related U.S. Application Data
(63) Continuation of application No. PCT/FR2009/001311, filed on Nov. 16, 2009.

(30) Foreign Application Priority Data
Nov. 17, 2008 (FR) 0806435

(51) Int. Cl. G06F 19/00

(52) U.S. Cl. 702/85

(57) ABSTRACT

A method of monitoring the voltage U_{ELT} of an electrical energy generating element of a battery, comprising measuring the voltage U_{BRUT} at the terminals of said element by means of a subtractor assembly and carrying out a calibrating procedure. The invention also relates to a monitoring device for the implementation of this method, a system for monitoring voltages of elements of a battery as well as an electric battery comprising at least one module formed from several electrical energy generating elements, said battery comprising, for each module, a system for monitoring voltages.

### CROSS-REFERENCE TO RELATED APPLICATIONS

This application is a continuation of International Patent Application No. PCT/FR2009/001311, filed on Nov. 16, 2009, which claims the benefit and priority of French Patent Application No. 0806435, filed Nov. 17, 2008. The entire disclosures of the above applications are incorporated herein by reference.

### BACKGROUND

The invention relates to method of monitoring the voltage of an electrical energy generating element of a battery, a monitoring device for the implementation of this method, as well as a system for monitoring voltages of the elements of a battery. The invention also relates to an electric battery comprising at least one module formed from several electrical energy generating elements, said battery comprising, for each module, a system for monitoring voltages.

The electric battery is in particular intended for electrical or hybrid motor vehicle traction, that is to say comprising an electric motor driving drive wheels combined with a thermal engine driving these wheels or possibly other drive wheels.

In particular, the invention applies to a high degree of hybridization of thermal vehicles which may go as far as complete electrification of the traction chain. In this case, the batteries do not then merely serve to assist the vehicles in the acceleration phases but also to provide movement of the vehicle autonomously over greater or lesser distances.

The electric battery according to the invention can also find its application in other technical fields, for example mobile electronics (computers, cameras, personal stereos, etc.) or in stationary applications such as solar panels.

To guarantee the levels of power and/or energy required for the applications in question, it is necessary to create batteries comprising a plurality of electrical energy generating elements which are, in particular, mounted in series.

For safety reasons, it is known that the generating elements must in no case be too charged or too discharged. This is particularly true when the generating elements comprise at least one electro-chemical cell, for example of the Lithium-ion or Lithium-polymer type, which is formed by a stack of electroactive layers acting successively as an anode and a cathode, said layers being put in contact by means of an electrolyte.

The chargers and other equipment items interfaced to the battery have a global vision of the voltage, whereas the voltages of the elements are not necessarily homogeneous and there is some variation between the voltages of each of the elements. Therefore, to guarantee the service life and the safety of the system, it is important to precisely monitor the lowest and the highest voltages within the battery.

Consequently, in order to guarantee the safety and the service life of the battery, the voltage of the elements must be precisely monitored. This monitoring of the voltages enables detecting the possible over-charges or over-discharges and allows for activating safety devices making it possible to prevent unwanted events from occurring.

When elements are mounted in series, it is also important to precisely measure the voltage of each of them so as to ensure their balancing. This balancing quality participates in the increase of the service life and of the safety of the battery.

The precision of the measuring of the voltages is also important for calculating the state of charge of the battery. Indeed, the state of charge of the battery in discharge is defined by the potential of the weakest element whereas, during recharge, it is the element with the highest potential which defines the state of charge.

In particular, measuring the voltage of the elements makes it possible to monitor the overvoltage risks before a risk of thermal runaway occurs; it also contributes to making the system more reliable and to increasing the duration of its service life. This measurement must be particularly reliable during the entire service life of the battery.

However, obtaining voltage values becomes all the more difficult as the size of the battery increases, which means that it comprises a great number of elements.

Different measuring devices can be used to obtain individually each of the voltages of the elements constituting a battery functioning at high voltage, particularly on the order of 200-400V.

Measuring each of the voltages can be carried out with respect to a general ground, common to the entire device for monitoring the battery. The observed drawback is that each measuring chain must be capable of carrying out a high voltage measurement, which leads to a very high cost.

The addition of a resistive bridge at each of the measuring chains eliminates the problem of obtaining high voltage; however, such a device leads to a loss of precision in measuring voltages.

Electromagnetic relays can also be used to successively take the voltage at the terminals of each one of the elements, but the cost of this solution is very high, the dimension of the relays can be a real source of problem in terms of needs in compactness of the battery and, most of all, such device does not allow for acquiring all of the voltages of the battery within reasonable lead-times.

It is also possible to isolate each measuring chain with optocouplers, but this solution remains very expensive and bulky. In particular, using a great number of optocouplers to separate galvanically each of the measuring chains leads to a high cost.

To enhance the precision of the voltage measurements of a battery functioning at high voltage, the patent U.S. Pat. No. 6,313,637, Iino et al., issued Nov. 6, 2001, proposes a measuring chain in which the acquisition of the voltages of each one of the elements is divided into modules, the voltage of each of the elements being acquired via an operational amplifier, converted by means of an analog-to-digital converter and digitally transmitted by means of an optocoupler to a processor.

This principle for measuring voltages considers that the performances of the electronic components constituting the acquisition chain are perfect and that the source of error is connected to the internal resistor of the battery elements which causes an increase of the errors of common mode in the subtractor assembly used for acquiring voltages.

This error of common mode becomes all the more pronounced as one moves away from the voltage reference and the principle of the measuring chain according to the document U.S. Pat. No. 6,313,637, Iino et al., issued Nov. 6, 2001, consists in limiting these effects of common mode by positioning the voltage reference at the center of the acquisition module.

Indeed, the differential amplifiers bring the voltage measurements back to a known reference, but transmit a voltage of common mode to each of the measuring channels. This common mode voltage is dependent upon the position of the element measured, its value increases with the distance with respect to the voltage reference. The operational amplifiers also bring an offset which is independent from the position of the measuring chain with respect to the ground.

Furthermore, the electronic monitoring devices of the battery elements use supplies to recreate a reference voltage in the measuring chains. In the document U.S. Pat. No. 6,313,637, Iino et al., issued Nov. 6, 2001, this voltage source is obtained from the 12V network of the vehicle.

Consequently, the monitoring devices according to the prior art consume energy on the auxiliary battery of the vehicle (12V or 24V battery), which can lead to a rapid discharge of the auxiliary battery when the vehicle is not used for several weeks.

In addition, the 12V networks installed on thermal vehicles are not necessarily sized to accommodate the additional consumptions constituted by this electronic monitoring.

Furthermore, the voltage references recreated from the 12V network are not very stable: they can be strongly disturbed by the numerous consumers integrated to the 12V line.

Using voltage references recreated from the 12V network can also lead to reliability issues. Indeed, a failure of the 12V network (discharged battery . . . ) causes the traction battery to no longer be monitored.

As reminded hereinabove, the voltage measurements of each of the battery elements constitute a real safety function, particularly because the quantity of energy provided in the battery is high. It is therefore necessary to have voltage measurements that are as precise and as reliable as possible. However, the voltage acquisition chains used in the batteries for electric vehicles according to prior art have several weaknesses.

First, their electronic architectures imply that the properties of the components are perfectly reliable and defined. However, it is generally accepted that the properties of the electronic components deteriorate over time and/or evolve as a function of the conditions of use (temperature . . . ).

In addition, the precision required in the voltage measurement of each of the battery elements to obtain measurements of the state of charge of the battery (SOC) which are precise and reliable (especially for the battery elements having “flat” polarization curves) would require using extremely precise resistors (and thus very expensive, or even impossible to find) in the subtractor assembly for acquiring voltages.

Furthermore, in case of a malfunction of the measuring chain, erroneous information of voltage values can be brought back to the system, which could have dramatic consequences for the safety of the battery. An over-estimated voltage measurement of the element can lead the system to an induced and non-detected discharge (respectively an under-estimated measurement, on a non-detected induced charge).

The voltage monitoring devices according to the prior art therefore have errors related to the offsets of the measuring chains, but also to the presence of a common mode which, being dependent upon the internal resistor of the battery elements, is susceptible of strongly evolving as a function of the aging of said elements and of their temperature. To these sources of inaccuracy, errors on the amplifier gain, the offset, and the gain depending essentially on the temperature can be added.

Calibrating the measuring chains on the production lines does not make it possible to take into account the variations of these errors with the temperature and the age of the elements. It is therefore crucial to be able to calibrate the chain before each measurement in order to compensate these errors and to eliminate the possible errors of non-linearity.

### SUMMARY

The invention aims at overcoming the drawbacks of the prior art by proposing, in particular, a simple and economical device for monitoring the voltage of an electrical energy generating element of a battery, said device having an excellent level of reliability in the precision of the voltage measurements, so as to be able to increase the duration of service life, the autonomy, the precision in the calculation of states of charge as well as the safety of the battery.

To this end, according to a first aspect, the invention proposes a method of monitoring the voltage U_{ELT} of an electrical energy generating element of a battery, said method providing for measuring the voltage U_{BRUT} at the terminals of said element by means of a subtractor assembly and by carrying out a calibration procedure comprising the following steps:
commutation of the inputs of the subtractor assembly on the sole positive terminal of the element and measurement of the calibration voltage U_{ETAL+} delivered by said assembly;
commutation of the inlets of the subtractor assembly on the sole negative terminal of the element and measurement of the calibration voltage U_{ETAL-} delivered by said assembly;
establishment of the average offset voltage U_{CORR} defined by the relationship

$${U}_{CORR} = \frac{( {U}_{ETAL +} ) + ( {U}_{ETAL -} )}{2} ;$$

correction of the measured voltage U_{BRUT} with the average offset voltage U_{CORR} to determine the voltage U_{ELT} of the element with the relationship U_{ELT}=U_{BRUT}−U_{CORR}.

According to a second aspect, the invention proposes a device for monitoring the voltage U_{ELT} of an electrical energy generating element of a battery by the implementation of such method, said device comprising a subtractor assembly made of resistors associated with an operational amplifier, said subtractor assembly comprising, in addition, two commutators enabling the commutation of the inputs of the operational amplifier respectively on a single terminal of the element, said device further comprising means for measuring the voltages delivered by said assembly and a digital processing unit comprising means for establishing the average offset voltage U_{CORR} and for correcting the measured voltage U_{BRUT}.

According to a third aspect, the invention proposes a system for monitoring voltages of the elements of an electric battery, said system comprising, for each element, such a monitoring device, the digital processing unit as well as the possible creation circuit of at least one reference voltage being common to said monitoring devices, said system further comprising an analog-to-digital converter of the voltage measurements and an optocoupler of the digital processing unit with a central system for managing the battery.

According to a fourth aspect, the invention proposes an electric battery comprising at least one module formed by several electrical energy generating elements, said battery comprising, for each module, such system for monitoring voltages.

### FIGURES

Other particularities and advantages of the invention will become apparent from the following description given with reference to the accompanying drawings, in which:

FIG. 1 shows a module of an electric battery as well as its system for monitoring voltages of elements forming said module;

FIG. 2 shows the wiring diagram of a first embodiment of a subtractor assembly for a monitoring device according to the invention;

FIG. 3 shows the wiring diagram of a creation circuit of two reference voltages to supply the subtractor assembly according to FIG. 2;

FIG. 4 shows the wiring diagram of a second embodiment of a subtractor assembly for a monitoring device according to the invention.

### DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

An embodiment of an electric battery comprising at least one module M formed by several electrical energy generating elements 1, which are mounted in series, is described below. In particular, the battery comprises several modules M which are mounted in series.

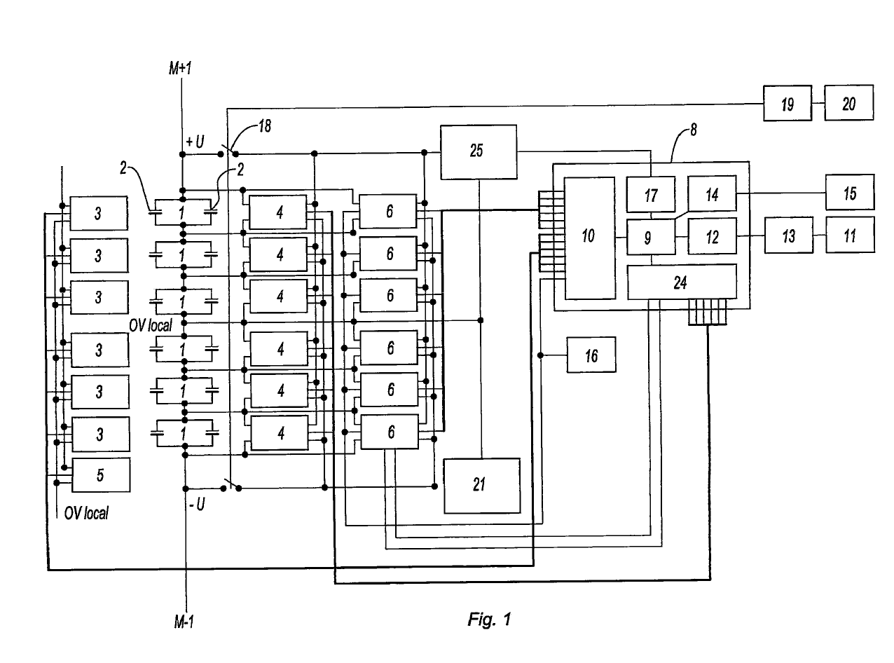

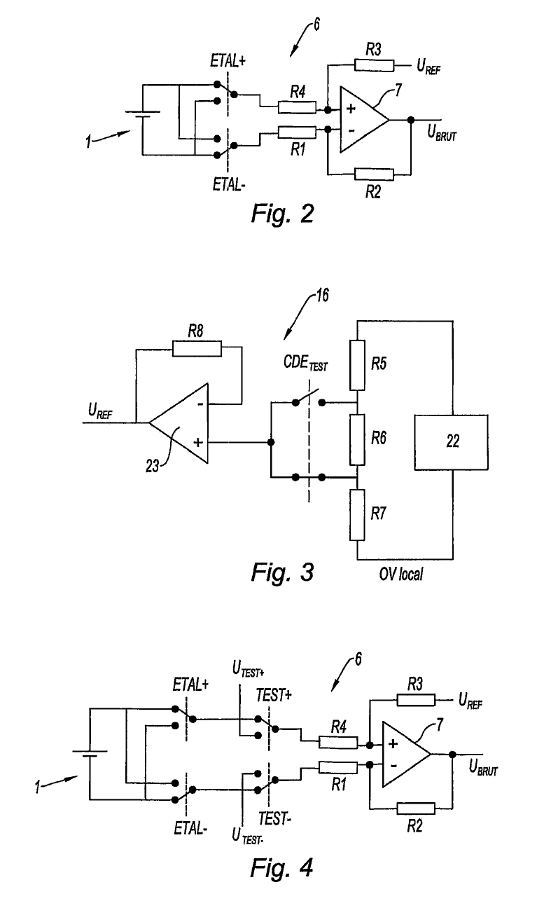

In FIG. 1, a module M is represented with its connections to the two adjacent modules M+1, M−1, said module comprising six elements 1 which are each formed with two electrochemical cells 2 mounted in parallel.

In an exemplary embodiment, the electrochemical cells 2 are of the Lithium-ion or Lithium-polymer type.

The assembly of the elements 1 presents a central potential—referred to as 0V local—situated between the third and the fourth element 1, said central potential defining the zero potential of the module M, on each side of which the three upper elements 1 are in a zone of positive potential and the three lower elements 1 in a zone of negative potential.

With respect to this central potential, the terminal of the third upper element 1 defines the positive supply +U of the module M, whereas the negative supply—U of the module M is defined by the terminal of the third lower element 1. Therefore, the module M delivers a variable voltage which depends on the state of charge of the elements 1. In particular, each of the elements 1 can be charged to the maximum at 5 V and discharged to the maximum at 1.7 V, so that the voltage delivered by the module is comprised between 15 V and 5 V.

The battery is more particularly adapted to supply a traction electric engine of a motor vehicle, whether it is an electric vehicle or one of the electric-thermal hybrid type. However, the battery according to the invention can also find its application for storing electric energy in other modes of transportation, particularly aeronautics. Furthermore, in stationary applications such as windmills, the battery according to the invention can also be used advantageously.

The battery further comprises, for each module M, a system for monitoring voltages, said system comprising, for each element 1, a device for monitoring the voltage of said element. In FIG. 1, the battery further comprises, for each element, a temperature measuring device 3 as well as a balancing device 4, as well as a device 5 for measuring ambient temperature.

The monitoring device comprises a subtractor assembly 6 made of four resistors R1-R4 associated with an operational amplifier 7. In addition, the subtractor assembly 6 comprises two commutators ETAL+, ETAL−, allowing for the commutation of the inputs of the operational amplifier 7 respectively on a single terminal of the element 1.

This device makes the monitoring of the voltage of an element 1 possible by providing for measuring the voltage U_{BRUT} at the terminals of said element by means of the subtractor assembly 6. In addition, the monitoring is carried out by providing for a calibration procedure which makes it possible to cancel the errors connected to the common mode and to the offset of the measuring chain.

The calibration procedure comprises the following steps:

activation of the commutator ETAL+ to switch the inputs of the subtractor assembly 6 on the sole positive terminal of the element 1 and measuring of the calibration voltage U_{ETAL+} delivered by said assembly;

deactivation of the commutator ETAL+ and activation of the commutator ETAL− to switch the inputs of the subtractor assembly on the sole negative terminal of the element and measuring of the calibration voltage U_{ETAL-} delivered by said assembly;

establishment of the average offset voltage U_{CORR} defined by the relation

$${U}_{CORR} = \frac{( {U}_{ETAL +} ) + ( {U}_{ETAL -} )}{2} ,$$

correction of the measured voltage U_{BRUT} with the average offset voltage U_{CORR} to determine the voltage U_{ELT} of the element with the relationship U_{ELT}=U_{BRUT}−U_{CORR}.

This calibration procedure makes it possible to correct the offset of the amplifier 7. To this end, the monitoring device further comprises means for measuring voltages delivered by the subtractor assembly 6 as well as a digital processing unit 8 comprising means for establishing the average offset voltage U_{CORR} and for correcting the measured voltage U_{BRUT}.

In relation to FIG. 1, the processing unit 8 comprises a processor 9, said unit being common to the monitoring devices of a module M. The unit further comprises an analog-to-digital converter 10 of the voltage measurements and an optocoupler 11 of the processor 9 with the central system for managing the battery. In an alternative that is not shown, the components of the processing unit 8 can be provided to be inconspicuous; in particular, the converter 10 can be dissociated from the processor 9.

In the illustrated embodiment, the communication between the unit 8 and the central management system is carried out via the digital link bus 12 of the motor vehicle, the interface 13 of this bus 12 being provided in the monitoring system. In addition, the monitoring system further comprises a reset function 14 between the processor 9 and an optocoupler 15. Furthermore, the unit 8 comprises a device 24 for communicating with the balancing devices 4.

Advantageously, the calibration procedure is carried out for each measurement of the U_{BRUT} voltage at the terminals of element 1. Furthermore, the calibration procedure can comprise a test to verify that the difference between the determined U_{ELT} and measured U_{BRUT} voltages is lower than the threshold voltage, a state of monitoring malfunction being established when the test is negative.

Besides the increase in precision of the measurement, such verification makes it possible to ensure an additional function of dependability to the extent that any malfunction of the measuring chain can be detected by comparing the value U_{CORR} with a previously determined threshold value. Alternatively, the values U_{CORR} of each element 1 can be compared to each other to detect a significant difference of correction between said elements. Indeed, particularly when the measuring chains are carried out with the same batch of electronic components, such difference signifies a monitoring malfunction which can be established by the verification test.

In the illustrated embodiment, the negative input of the amplifier 7 is supplied by means of a resistor R3 with a reference voltage U_{REF}. The reference voltage U_{REF} is measured to be subtracted from the measured voltage U_{BRUT} in determining the voltage of the element U_{ELT}.

To this end, the monitoring device further comprises a creation circuit 16 of at least one reference voltage U_{REF} which supplies the subtractor assembly 6. In FIG. 1, the monitoring system comprises a circuit 16 which is common to the monitoring devices of a module M, the processing unit 8 being supplied with the measurement of reference voltage U_{REF} by means of a converter 10 so as to be able to implement the monitoring method.

The processing unit comprises an electric supply 17 which is electrically fed by the variable continuous voltage which is delivered by the elements 1 of the module M. To this end, the supply circuit has an interruptor 18 which is controlled by the central system for managing the battery by means of a wake-up function 19 associated with an optocoupler 20.

In the illustrated embodiment, the supply is carried out with the upper elements 1 and the battery integrates a device 21 for compensating the consumption on the lower elements 1 so as to maintain the balancing between said elements.

With reference to FIGS. 1 and 3, the circuit 16 comprises a voltage reference 22 whose voltage, for example 5V, is divided by a resistive bridge comprising an operational amplifier 23 and resistors R5-R8. In particular, as represented in FIG. 1, current is supplied to the voltage reference 22 by a stabilized supply 25. In addition, the reference voltage U_{REF} is established between the voltage reference 22 and the local central potential 0V of the circuit series with the elements 1.

To enable the implementation of a verification procedure, the circuit 16 comprises a selector CDE_{TEST} to deliver two different reference voltages. The first (position of the selector in FIG. 3), for example on the order of 0.2V, corresponds to a counter-polarization voltage with which the voltage measurement U_{BRUT} at the terminals of the element 1 is carried out. Therefore, by providing for the counter-polarization voltage to be greater than the measurement error, a slight offset of the measured voltage U_{BRUT} is carried out so a slightly negative voltage is read as positive in the area of the converter 10.

The second voltage referred to as verification voltage U_{VER} can be greater than the counter-polarization voltage to present a value comprised between 80% and 120% of the maximum voltage of the element 1. Therefore, the verification of the gain of the amplifiers is carried out at a voltage which corresponds to the measuring range.

The verification procedure thus comprises the steps of:

activating the selector CDE_{TEST} to generate the verification voltage U_{VER} and measuring said generated voltage;

supplying the subtractor assembly 6 with said verification voltage as reference voltage;

measuring a calibrating voltage U_{ETAL}_{_{—}}_{VER} delivered by said assembly;

carrying out a test to verify that the difference between the measured voltage U_{VER} and the calibrating voltage U_{ETAL}_{_{—}}_{VER} is lower than a threshold voltage, a state of monitoring failure being established when the test is negative.

Furthermore, the monitoring process being iterative, the calibrating voltage U_{ETAL}_{_{—}}_{VER} can be corrected with an average offset voltage U_{CORR} previously defined, so as to benefit from the previous calibration.

In particular, the verification procedure can be carried out for each measurement of the voltage U_{BRUT} at the terminals of element 1, and the average offset U_{CORR} used can correspond to that defined for the previous measurement of said voltage.

Still for the purpose of securing the monitoring, the verification procedure can comprise a test to verify that the value of the verification voltage U_{VER} is comprised in a given range, a state of monitoring failure being established when the test is negative.

In addition, the monitoring process can provide for a test to verify that the value of the counter-polarization voltage is within a given range, a state of monitoring failure being established when the test is negative.

With reference to FIG. 4, a subtractor assembly which allows for the implementation of a procedure for compensating the gain of said assembly, is described below, said procedure providing for:

generating a first voltage test U_{TEST+} and measuring said generated voltage;

supplying the subtractor assembly 6 with said test voltage to determine the gain G+ on the positive input of said assembly;

generating a second voltage test U_{TEST-} and measuring said generated voltage;

supplying the subtractor voltage 6 with said test voltage for determining the gain G− in the negative input of said assembly;

calculating the average gain with the relationship

$${G}_{MOY} = \frac{{G}_{+} + G \_}{2} ;$$

compensating the determined voltage U_{ELT} by the average gain G_{MOY} with the relationship

$${U}_{CORR \_ ELT} = \frac{{U}_{ELT}}{{G}_{MOY}} .$$

To this end, the subtractor assembly comprises two other commutators TEST₊, TEST₋ which are mounted in series respectively with a commutator E_{TAL+}, E_{TAL-}, and the circuit is arranged to deliver four reference voltages, respectively the counter polarization voltage U_{REF}, the verification voltage U_{VER} and the two test voltages U_{TEST+}, U_{TEST-}.

The invention makes it possible to use resistors R1-R8 on the order of 100 kOhms with a precision of 0.1% and a variation of 25 ppm/° C. and amplifiers 7, 23, of the type OP747 from Analog Devices, while presenting an excellent level of reliability in the precision of the voltage measurements U_{BRUT} carried out.

In particular, the invention makes it possible to guarantee a precise definition of the state of charge of the battery. Indeed, the discharge curves of the elements 1 present an evolution of their off-load voltage as a function of their residual capacity. The slope of this discharge curve is more or less pronounced as a function of the chemical composition of the element 1 and the increase of the measurement precision becomes all the more critical as the slope becomes “flat”.

However, by eliminating the voltage errors connected to the presence of the common modes, the invention makes it possible, in most cases, to obtain a precision of voltage measurement lower than 4 mV. In addition, the invention makes it possible to detect measurement errors and to compensate them, but also to compensate the over-time deterioration of the performances of the electronic components, which is a real asset in terms of dependability.

All told, the invention makes it possible, in particular, to cumulate the following advantages:

increase the precision of voltage measurement and compensate the measurement errors connected to poor performance of malfunction of the measuring chain;

implement an auto-calibrated and auto-tested measuring chain, particularly for Li-ion batteries;

erase the imperfections of the components;

erase the over-time deteriorations of properties of the components;

guarantee an excellent balancing quality;

participate to the dependability of the battery;

limit the number of optocouplers (economical gain);

carry out precise SOC calculation of elements 1 having flat discharge curves;

correct the temperature deteriorations of the measuring chains.

1-19. (canceled)

20. A method of monitoring the voltage U_{ELT} of an electrical energy generating element of a battery, said method providing for measuring the voltage U_{BRUT} at the terminals of said element using a subtractor assembly and by carrying out a calibration procedure comprising the following steps:
switching the inputs of the subtractor assembly on the sole positive terminal of the element and measure the calibration voltage U_{ETAL+} delivered by said assembly;
switching the inputs of the subtractor assembly on the sole negative terminal of the element and measure the calibration voltage U_{ETAL-} delivered by said assembly;
establishing the average offset voltage U_{CORR} defined by the relationship
$${U}_{CORR} = \frac{( {U}_{ETAL +} ) + ( {U}_{ETAL -} )}{2} ;$$
and
correcting the measured voltage U_{BRUT} with the average offset voltage U_{CORR} to determine the voltage U_{ELT} of the element (1) with the relationship U_{ELT}=U_{BRUT}−U_{CORR}.

21. The method according to claim 20, wherein the calibrating procedure is carried out for each voltage U_{BRUT} measurement at the terminals of the element.

22. The method of monitoring according to claim 20, wherein the calibrating procedure comprises a test to verify that the difference between the determined U_{ELT} and measured U_{BRUT} voltages is lower than the threshold voltage, a state of monitoring malfunction being established when the test is negative.

23. The method of monitoring according to claim 20, wherein the subtractor assembly is supplied with a reference voltage U_{REF}, said reference voltage being measured to be subtracted from the measured voltage U_{BRUT} in determining the voltage U_{ELT} of the element.

24. The method of monitoring according to claim 23, wherein the method provides for a verification procedure comprising
generating a verification voltage U_{VER} and measuring said generated voltage;
supplying the subtractor assembly with said verification voltage as reference voltage;
measuring a calibrating voltage U_{ETAL}_{_{—}}_{VER} delivered by said assembly; and
carrying out a test to verify that the difference between the measured voltage U_{VER} and the calibrating voltage U_{ETAL}_{_{—}}_{VER} is lower than a threshold voltage, a state of monitoring failure being established when the test is negative.

25. The method of monitoring according to claim 24, wherein the calibrating Voltage U_{ETAL}_{_{—}}_{VER} is corrected with an average offset voltage U_{CORR} previously defined.

26. The method of monitoring according to claim 24, wherein the verification procedure comprises a test to verify that the value of the verification voltage U_{VER} is comprised in a given range, a state of monitoring failure being established when the test is negative.

27. The method of monitoring according to claim 24, wherein the verification procedure is carried out for each voltage U_{BRUT} measurement at the terminals of the element.

28. The method of monitoring according to claim 24, wherein the verification voltage U_{VER} is higher than the reference voltage U_{REF}.

29. The method of monitoring according to claim 28, wherein the verification voltage U_{VER} has a value comprised between 80% and 120% of the maximum voltage of the element.

30. The method of monitoring according to claim 23, wherein the method provides for a test to verify that the value of the reference voltage U_{REF} is comprised within a given range, a state of monitoring failure being established when the test is negative.

31. The method of monitoring according to claim 23, wherein the element is mounted in series with other elements to form a module, the reference voltage U_{REF} being established between a reference voltage and the central potential of said circuit series.

32. The method of monitoring according to claim 20, wherein the method comprises a procedure for compensating the gain of the subtractor assembly, said procedure comprising
generating a first test voltage U_{TEST+} and measuring said generated voltage;
supplying the subtractor assembly 6 with said test voltage to determine the gain G₊ on the positive input of said assembly;
generating a second test voltage U_{TEST-} and measuring said generated voltage;
supplying the subtractor assembly with said test voltage for determining the gain G₋ on the negative input of said assembly;
calculating the average gain with the relationship
$${G}_{MOY} = \frac{{G}_{+} + G \_}{2} ;$$
and
compensating the determined voltage U_{ELT} by the average gain G_{MOY} with the relationship
$${U}_{CORR \_ ELT} = \frac{{U}_{ELT}}{{G}_{MOY}} .$$

33. A device for monitoring the voltage U_{ELT} of an electrical energy generating element of a battery by implementing a method according to claim 20, said device comprising a subtractor assembly carried out with resistors (R1-R4) associated with an operational amplifier, said subtractor assembly further comprising two commutators (ETAL₊, ETAL₋) enabling the commutation of the inputs of the operational amplifier respectively on a single terminal of the element, said device further comprising means for measuring the voltages delivered by said assembly and a digital processing unit comprising means for establishing the average offset voltage U_{CORR} and for correcting the measured voltage U_{BRUT}.

34. The device for monitoring according to claim 33, wherein the device further comprises a circuit for creating at least one reference voltage which supplies the subtractor assembly.

35. The device for monitoring according to claim 34, wherein the circuit comprises a reference voltage whose voltage is divided by a resistive bridge comprising an operational amplifier and resistors (R5-R8), said circuit further comprising a selector (CDE_{TEST}) to deliver two different reference voltages.

36. A system for monitoring voltages of the elements of an electric battery, said system comprising, for each element, a monitoring device according to claim 33, the digital processing unit as well as the possible creation circuit of at least one reference voltage being common to said monitoring devices, said system further comprising an analog-to-digital converter of the voltage measurements and an optocoupler of the digital processing unit with a central system for managing the battery.

37. An electric battery comprising at least one module formed from several electrical energy generating elements, said battery comprising, for each module, a system for monitoring voltages according to claim 36.

38. The electric battery according to claim 37, wherein the monitoring system is electrically fed by means of the elements.
